(19) United States
(12) Patent Application Publication
(10) Pub. No.: US 2007/0162182 A1
(43) Pub. Date: Jul. 12, 2007

(54) Cabinet monitoring and reporting apparatus and system

(76) Inventors: Juan E. Marti, Danville, CA (US); Thomas Keane, Danville, CA (US)

Correspondence Address: DICKSTEIN SHAPIRO LLP, 1825 EYE STREET NW, Washington, DC, 20006-5403, US

(21) Appl. No.: 11/606,123

(22) Filed: Nov. 30, 2006

Related U.S. Application Data
(60) Provisional application No. 60/741,679, filed on Dec. 1, 2005.

(51) Int. Cl. G07F 11/00

(52) U.S. Cl. 700/236; 221/6

(57) ABSTRACT

Embodiments of the invention include a vending cabinet monitoring system, apparatus and method. A system according to the invention includes a plurality of cabinets configured to hold inventory. Each cabinet has at least one sensor configured to sense data about at least one of an operation of the first cabinet and an amount of inventory within the first cabinet and a computer device for collecting data from the at least one sensor and transmitting the data. A host system is in communication with the computer device of each cabinet. The host system receives the data from each cabinet processes the data to determine whether a cabinet needs to be restocked or maintained.

This application claims priority from U.S. provisional patent application No. 60/741,679 filed Dec. 1, 2005, the disclosure of which is incorporated herein by reference.

### BACKGROUND

The invention relates to cabinets and more particularly to a cabinet monitoring and reporting apparatus and system.

Cabinets have been used to distribute ice cream and frozen novelties to small retail outlets such as convenience stores, gas stations, liquor stores, and markets. Frequently, these cabinets are branded and contain only products from that brand.

Traditionally, these cabinets had to be manually monitored to determine stocking need and system health. For example, a driver would be required to drive to each location and visually determine if the cabinet needed to be restocked or serviced. Frequently, the cabinet would be in working order and would not need to be restocked, making this manual process very inefficient. Accordingly, there is a need and desire for remote cabinet(s) that is/are able to communicate stocking and service information to a central host system to eliminate this inefficiency. Existing technology related to vending machine monitoring is not well suited for cost-effective, simple application to remote monitoring of vending cabinets, such as ice cream freezer cabinets. An affordably priced system is needed that reduces or eliminates unproductive driver stops; is able to proactively react to changes of stocking and service conditions in real time, such as sudden surge in consumption due to an event like a carnival; alerts distributors of equipment failures; and provides data mining techniques to more accurately calculate rates of consumption.

While traditional vending machines have been monitored, and other types of monitoring systems exist, these systems are cost prohibitive for certain businesses, such as an ice cream and frozen novelty distribution network, particularly for rural or remote locations. The existing systems require new equipment, require costly upgrades, or have not been suited for an open cabinet design, such as a freezer or refrigerator. There is a need for an inexpensive, accurate monitoring system that can be incorporated into existing cabinets and is easy to install.

### SUMMARY

The present invention greatly alleviates these needs by providing a vending cabinet monitoring system that includes a plurality of cabinets configured to hold inventory, each cabinet having at least one sensor configured to sense data about at least one of an operation of the first cabinet and an amount of inventory within the first cabinet, and a computer device for collecting data from the at least one sensor and transmitting the data, and a host system in communication with the computer device of each cabinet, the host system for receiving the data from each cabinet, the host system configured to process the data to determine whether a cabinet needs to be restocked or maintained.

In one aspect, the system includes a distribution system in communication with the host system, the distribution system having devices for receiving information about whether a cabinet needs to be restocked or maintained.

In another aspect the host system is further configured to determine a route for maintaining or restocking the plurality of cabinets.

In another embodiment, the invention provides a cabinet monitoring apparatus, including a cabinet configured to hold inventory, a weight sensor for sensing a weight of the cabinet and any inventory, and a computer device for collecting data from the weight sensor.

In one aspect, the apparatus has an optical sensor for sensing the height of the inventory, and the computer device collects data from the optical sensor.

In another aspect, the apparatus further includes an entry sensor for sensing when the cabinet is accessed, and the computer device collects data from the entry sensor.

In other aspects, the apparatus has a temperature sensor for sensing the temperature inside the cabinet and the computer device collects data from the temperature sensor, or the apparatus has a voltage sensor for sensing the voltage of devices powering the cabinet and the computer device collects data from the voltage sensor, or the apparatus has a communication device for communicating the data to a remote host system.

In a further embodiment, a cabinet monitoring apparatus includes a cabinet configured to hold inventory, an entry sensor for sensing when the cabinet is accessed, and a computer device for collecting data from the entry sensor and storing the number of times that the cabinet is accessed during a period of time.

In other aspects, the apparatus has an optical sensor for sensing the height of the inventory and the computer device collects data from the optical sensor, or the apparatus has a temperature sensor for sensing the temperature inside the cabinet and the computer device collects data from the temperature sensor, or the apparatus has a voltage sensor for sensing the voltage of devices powering the cabinet and the computer device collects data from the voltage sensor, or the apparatus has a communication device for communicating the data to a remote host system, or the apparatus has a weight sensor for sensing the weight of the cabinet and the cabinet's contents.

In another embodiment the present invention provides a method of monitoring a vending cabinet, including the steps of providing a plurality of cabinets at a plurality of locations, each cabinet configured to hold inventory and having a computer device, sensing data related to a first cabinet, the data including at least one of an operation of the first cabinet and an amount of inventory within the first cabinet, collecting the data using the respective computer device, transmitting the data and first cabinet identification information to a remote host system, and processing the data to determine whether the first cabinet needs to be restocked or maintained.

In other aspects, the method includes the step of sensing a number of times the cabinet is accessed within a period of time, or the step of sensing a weight of the cabinet and the inventory within the cabinet, or the step of communicating to a distribution system the determination of whether the cabinet needs to be restocked or maintained, or the step of sensing at least one of a temperature within the first cabinet, a height of the inventory and a voltage of a power source.

In another aspect, the method further includes the steps of sensing second data about at least one of an operation of the second cabinet and an amount of inventory within the second cabinet, collecting the second data using the respective computer device, transmitting the second data to the remote host system, and processing the second data to determine whether the second cabinet needs to be restocked or maintained.

In another aspect, the method further includes the step of determining a route for restocking or maintaining the first and second cabinets based on the determination of whether the first and second cabinets need to be restocked or maintained.

The foregoing and other advantages and features of the invention will become more apparent from the detailed description of exemplary embodiments provided below with reference to the accompanying drawings.

### BRIEF DESCRIPTION OF THE DRAWINGS

FIG. 1 shows a block diagram illustrating a cabinet monitoring system according to an embodiment of the invention;

FIG. 2 shows a block diagram illustrating a cabinet monitoring apparatus according to an embodiment of the invention;

FIGS. 3A-3C shows a block diagram of a cabinet with weight sensors constructed in accordance with embodiments of the invention;

FIG. 4A shows a block diagram of a cabinet with optical sensors constructed in accordance with an embodiment of the invention; and

FIG. 4B is a cross-sectional view of a portion of the cabinet of FIG. 4A.

### DETAILED DESCRIPTION OF PREFERRED EMBODIMENTS

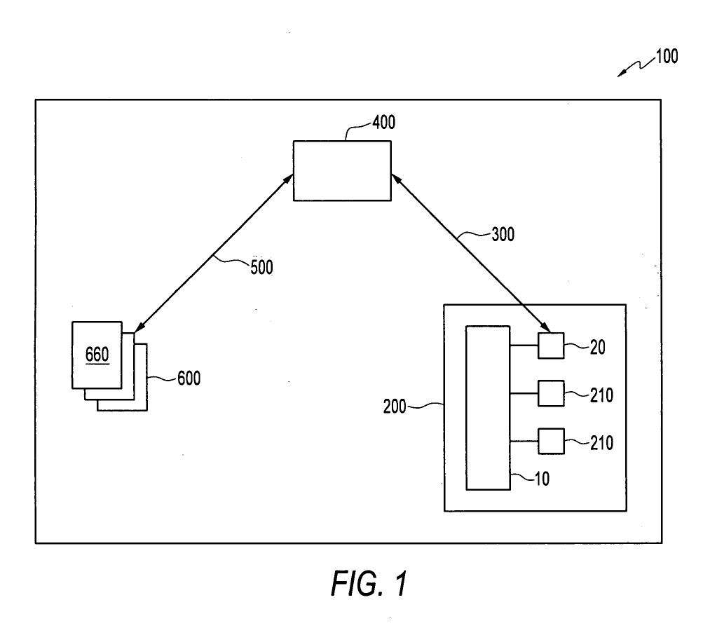

FIG. 1 shows a cabinet monitoring system 100 according to one embodiment of the invention. The cabinet monitoring system 100 includes one or more cabinet monitoring apparatuses 200. Each cabinet monitoring apparatus 200 includes a cabinet 10, such as a freezer for vending ice cream and frozen novelties, with a black box 20 and one or more sensors 210, such as weight sensors or entry sensors that collect data relating to system health or inventory. The sensors 210 transmit data to the black box 20, which is a computer device including memory and communications device. In an embodiment of the invention, the black box 20 communicates with the sensors 210. The black box 20 can also collect and/or transmit data in addition to the sensor 210 data, such as radio frequency identification (RFID) data indicating the identity of the particular cabinet monitoring apparatus 200, among others.

The black box 20 transmits data to a host system 400, through a communication network 300. In an embodiment of the invention, the host system 400 communicates with the black box 200 via the telephone lines present at the location of the cabinet monitoring apparatus 200. In one embodiment of the invention, the host system 400 is capable of processing data from the black box 20 as well as historical data and external data such as weather data to better predict when the cabinet or cabinet monitoring apparatus will need servicing or restocking. In an embodiment of the invention, the host system 400 includes an external means of accessing the data contained therein, such as a web site for providing access to the data via the Internet.

The host system 400 is a central database and communication application that collects information from one or more black boxes 20 and then stores the data collected into a database. The host system can also store data from other sources, including sales data for specific products from each location having a cabinet monitoring apparatus 200. In addition, the host system 400 provides for the custom configuration parameters of each black box 20 including, for example, when to communicate with the black box 20, how often to communicate with the black box 20, and what constitutes alert conditions that would trigger an automatic response from the black box 20. The host system 400 can also be programmed to upgrade the firmware (operating instructions) of each black box 20 and clear the memory of the data stored in the black box 20 after collecting the data to prevent duplicative processing of data.

The host system 400 is configured to process the data from each black box 20 to determine whether a particular cabinet 10 needs to be restocked or whether a particular cabinet monitoring apparatus 200 needs to be maintained. Further, the host system 400 is configured to plan distribution and maintenance routes based on which cabinets 10 need to be restocked and which apparatuses 200 need to be maintained and the location of each cabinet 10 or apparatus 200. Additionally, the host system 400 is configured to use the data from the black boxes 20 as well as specific sales information to determine which products should be sold at which locations and in which cabinets 10. In this manner, routes can be efficiently planned saving time and/or money.

The host system 400 transmits data to a distributor system 600 through a communication network 500, such as a wireless communications network. The distributor system 600 can also communicate with the host system 400. The distributor system 600 can include one or more devices 660, such as pagers, handheld devices, or other devices that allow the distributors and other service providers to receive information. For example, the data transmitted to the distributor system 600 devices 660 can be used to indicate when a delivery person or service technician needs to visit the location of a cabinet monitoring apparatus 200, the routes to follow when restocking and servicing the cabinets 10 and what repairs need to be made to a particular monitoring apparatus 200. The host system 400 can be viewed as an ASP (Application Service Provider) whereby customers, product distributors, interested in maximizing their productivity, can be notified in real time of inventory and maintenance needs.

The devices 660 are integral components to the overall inventory management system, especially as it pertains to collecting and separating SKU product levels. The sensors 210 detect general information about product level and/or operation of a cabinet 10. The devices 660 can store and collect data regarding specific products that constitute the inventory within a cabinet 10. For example, a device 660 at the point of stocking/selling to the cabinet, affords an excellent opportunity to collect data regarding which specific products are low, empty or full. Further, the devices 660 can collect information about product placement within a cabinet 10. For this, the device 660 user (i.e., a distributor or servicer) inputs the information into the device 660. Data collected by the devices 660 is communicated to the host system 400. In turn, the host system 400 can provide information to the devices 660, including information about what products are sold and the distribution and service routes.

It should be appreciated that the communication networks 300 and 500 can be implemented with any known communication system, such as wireless (CDMA, GPRS, GSM), telephone lines, WIFI, Ethernet, fiber optic, or cable.

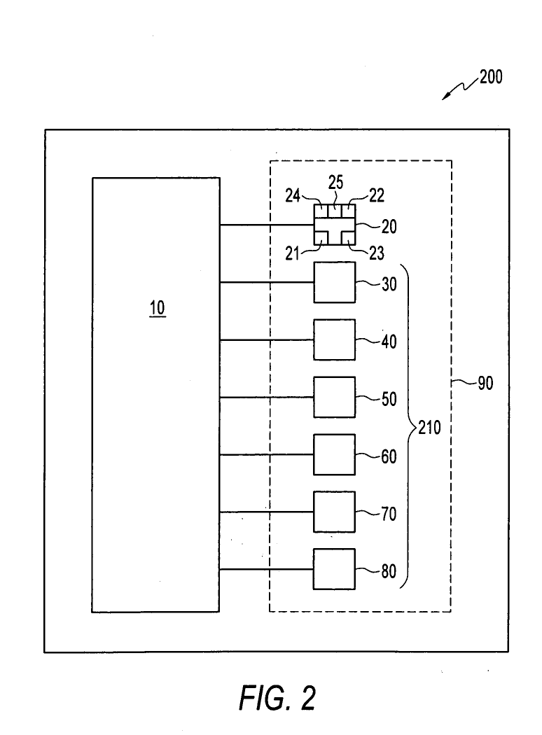

FIG. 2 shows an exemplary cabinet monitoring apparatus 200 including a cabinet 10 fitted with a black box 20. The exemplary cabinet 10 is a freezer for distributing ice cream and frozen novelties; however, other cabinets could be used in the invention, including, for example, a storage compartment such as a refrigerator. The cabinet monitoring apparatus 200 further includes a plurality of sensors 210 in communication with the black box 20, such as an entry sensor 30, a temperature sensor 40, a humidity sensor 50, a weight sensor 60, an optical sensor 70, and a voltage sensor 80.

In an exemplary embodiment of the invention, the black box 20 is a computer device that provides interfaces to the sensors 30-80 and samples the data at programmable intervals, such as thirty seconds, one minute, four hours, or once per day. The black box 20 contains a communication device 25, which includes communication controller, and may be configured to utilize one or more of the following: GPRS, GSM, CDMA, Phone Line, and Ethernet. Optionally, the black box 20 includes a back up power source 21, such as a battery, to enable the black box to function in the event the power source (not shown) to the cabinet 10 fails. In one embodiment, the black box 20 has a status display 22, such as a screen and/or LCD lights to provide status information. The black box 20 can also include one or more switches 23 or other means to manually restore the cabinet monitoring apparatus to original factory settings, to manually force a communication with the host system 400 (FIG. 1), and/or to enable the black box 20 to be contacted by the host system 400 as opposed to only black box 20 initiated communication.

The black box 20 stores the data from the sensors 210 in memory 24 and communicates with the host system 400 at preprogrammed times and/or based on configurable options, such as those described below. In one embodiment, the black box 20 communicates with the host system 400 via phone lines and is connected to the phone lines present at the location of the cabinet monitoring apparatus 200. Alternatively, wireless technology (like GSM) can also be used to provide communication between the black box 20 and the host system 400.

In one embodiment, wireless technology (like Zigbee) could be used to network multiple black boxes 20 present at a single location or at multiple locations in close proximity to one another. Networking the black boxes 20 would lower the recurring connectivity costs to operate multi-unit locations. Further, only one black box 20 per location (a “master unit”) would require a communication controller while the other black boxes 20 at the location would function as “slave” or be controlled by the master unit.

From the data received from the one or more black boxes 20, the host system 400 determines whether and when a particular cabinet 10 needs to be restocked and/or serviced. Where the cabinet monitoring system 100 includes multiple cabinets 10 at various locations, the host system 400 can also configure the routes and schedules to be used by the delivery personnel and/or maintenance personnel who restock and service the cabinet monitoring apparatuses 200.

Each of the sensors 30-80 is described in more detail below. While particular sensors 30-80 are shown, it should be readily understood that additional or fewer sensors 210 can be included depending on the desired monitoring points.

The entry sensor 30 senses how many times the cabinet 10 has been accessed and transmits data to the black box 20. The entry sensor is placed the door or entry means to the cabinet 10. If the cabinet 10 has more than one door, multiple entry sensors 30 are used. The entry sensor 30 provides an inexpensive way to predict inventory needs in a cabinet 10. The black box 20 can be programmed to contact the host system 400 when the entry sensors 30 indicate that the cabinet 10 has been accessed a certain number of times.

The temperature sensor 40 senses the temperature inside the cabinet 10 and transmits data to the black box 20. The temperature sensor 40 may also be configured to detect the temperature outside of the cabinet 10 or an additional temperature sensor 40 may be placed on the outside of the cabinet 10. In one embodiment, temperature sensors 40 are used to monitor the operation of the freezer compressor (not shown) for predicting compressor failures. For this, the compressor input temperature, the compressor output temperature, and the ambient temperature are monitored. These temperature readings could be used in conjunction with the compressor manufacturer's statistical analysis to predict compressor health and anticipate servicing needs for the cabinet 10 compressor. The black box 20 can be programmed to contact the host system 400 when the temperature sensors 40 indicate that the temperature at a particular place is above or below a certain predetermined temperature or temperature range.

The humidity sensor 50 senses the humidity inside the cabinet 10 and transmits data to the black box 20. A humidity sensor is more desirable in the case where the cabinet 10 is a refrigerator rather than a freezer. The black box 20 can be programmed to contact the host system 400 when the humidity sensor 50 indicates that the humidity within the cabinet 10 is above or below a certain predetermined humidity or humidity range.

One or more weight sensors 60 senses the weight of the cabinet and its contents and transmits data to the black box 20. The black box 20 can be programmed to contact the host system 400 when the weight sensors 60 indicate that the weight of the cabinet and its contents have fallen below a certain predetermined weight. In one embodiment, the weight sensors 60 are load cells, which are devices that measure deflection measured in voltage which translates into weight, however other sensors for sensing weight can be used.

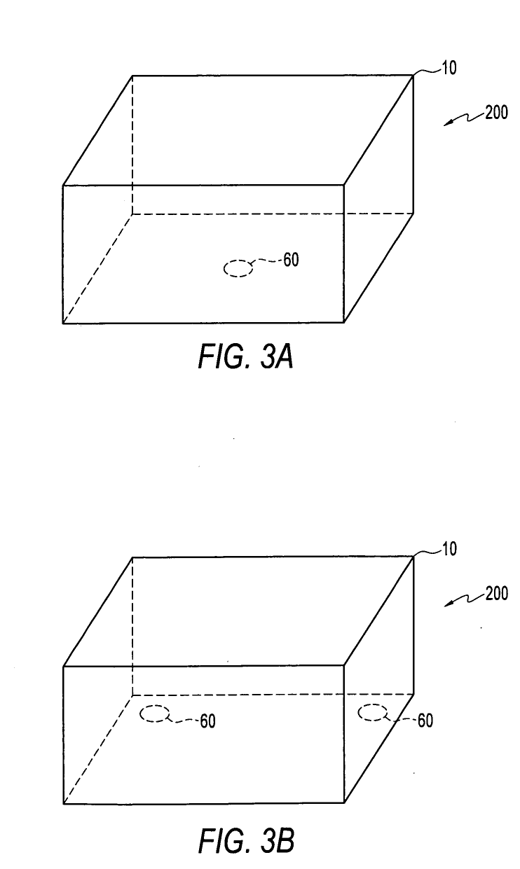

Referring to FIG. 3A, one load cell 60 can be used to determine if the cabinet 10 is 25%, 50%, 75%, or 100% full. Alternatively, as shown in FIG. 3B, two load cells 60, on each corner on the back side of the cabinet 10, are used to weigh the cabinet 10 and its contents, yielding an accuracy of 10%, 20%, 30%, . . . 90%, 100%.

In another embodiment shown in FIG. 3C, casters 810 integrated with load cells 60 are mounted to the bottom side of a frame 800. The load cells 60 are specifically designed for a caster/wheel, such as those created by Sentran, LLC. The cabinet 10 is placed onto the frame 800. It should be appreciated that the frame 800 may be built in any size or shape that is capable of supporting the cabinet 10. While four casters 810 with integrated load cells 60 are shown, any number of casters 810 with integrated load cells 60 may be used. A combination of traditional casters and casters 810 with integrated load cells 60 may also be used. While the caster/wheels are shown, it should be appreciated that the load cells or other weight sensor can be incorporated with any support mechanism such as a foot.

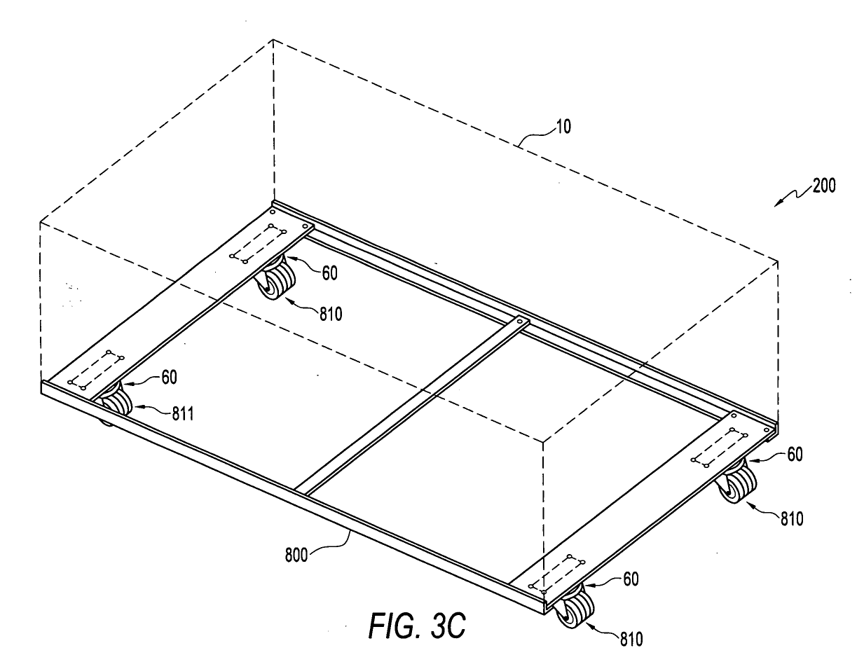

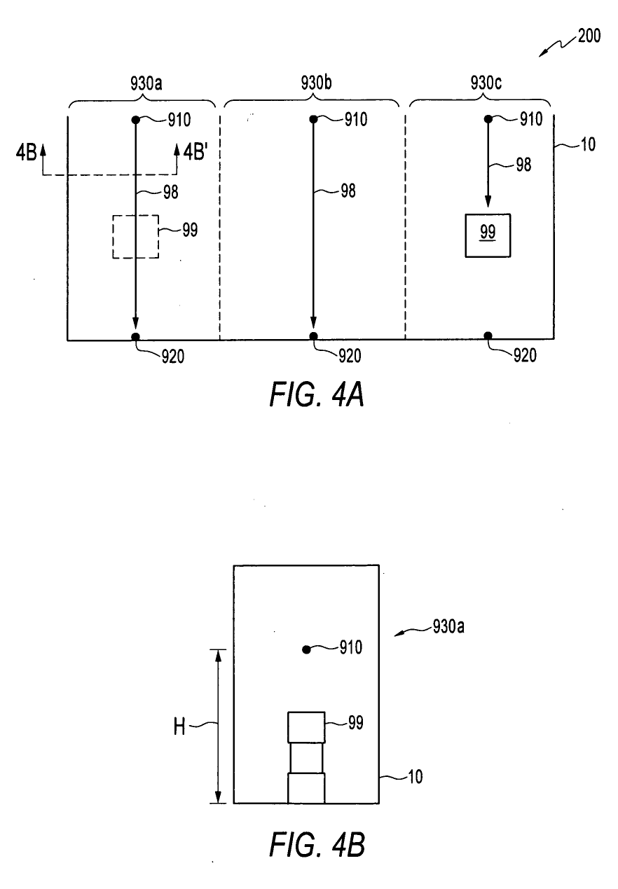

The optical sensor 70 senses the level, or height, of inventory in the cabinet. FIGS. 4A is a top-down view of a cabinet 10 including optical sensors 70 according to one embodiment and FIG. 4B is a cross-sectional side view of the cabinet 10 along the line 4B-4B′. As shown in FIG. 4A, one or more pairs of send sensors 910 and receive sensors 920 are positioned at intervals along the interior sides of a cabinet 10. In one embodiment, the vending cabinet 10 can be subdivided into sections or compartments 930a, 930b, 930c, and a send and receive optical sensor pair 910, 920 is positioned at a particular height H in each compartment 930a, 930b, 930c. The send sensor 910 sends an optical signal 98, which is received by the corresponding receive sensor 920 where there is a clear horizontal path, i.e., no inventory 99 to block the sent signal 98. For example, in compartment 930c, there is sufficient inventory 99 such that the inventory 99 reaches a height sufficient to block the sent signal 98. However, while compartment 930a contains inventory 99, the inventory is insufficient to reach a height to block the sent signal 98. If one sensor pair 910, 920 is used per compartment 930a, 930b, 930c, the sensor is preferably placed at a height H, such that when a signal is received that the inventory 99 is below the height H, there is time to restock the cabinet 10 before the inventory 99 is completely gone.

The voltage sensor 80 senses the main power to the cabinet. The black box 20 can be programmed to contact the host system 400 when the voltage sensor 80 indicates a low voltage or a power failure (no voltage) condition.

The cabinet monitoring apparatus 200 can be manufactured as a unit with the black box 20 and sensors 30-80 integrated with the vending cabinet 10. Alternatively, existing cabinets can be modified to be a cabinet monitoring apparatus 200 using a kit 90. Kit 90 includes a black box 20, sensors 30-70, that can be installed on a vending cabinet 10, and the components and connections needed to install the black box 20 and sensors 30-70 such that they function as described herein. With the kit 90 vendors can upgrade their existing cabinets 10 to enable monitoring rather than incur the expense of entirely replacing the existing cabinets.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While preferred embodiments of the invention have been described and illustrated above, it should be understood that these are exemplary of the invention and are not to be considered as limiting. For example, although an exemplary embodiment has been described in connection with an ice cream and frozen novelty vending freezer monitoring and distribution apparatus and system, the invention is applicable to other cabinets, such as refrigerators or vending machines, for example. Additions, deletions, substitutions, and other modifications can be made without departing from the spirit or scope of the invention. Accordingly, the invention is not to be considered as limited by the foregoing description but is only limited by the scope of the appended claims.

What is claimed as new and desired to be protected by Letters Patent of the United States is:

1. A vending cabinet monitoring system, comprising:
a plurality of cabinets configured to hold inventory, each cabinet comprising:
at least one sensor configured to sense data about at least one of an operation of the first cabinet and an amount of inventory within the first cabinet; and
a computer device for collecting data from the at least one sensor and transmitting the data;
a host system in communication with the computer device of each cabinet, the host system for receiving the data from each cabinet, the host system configured to process the data to determine whether a cabinet needs to be restocked or maintained.

2. The system of claim 1, further comprising a distribution system in communication with the host system, the distribution system comprising devices for receiving information about whether a cabinet needs to be restocked or maintained.

3. The system of claim 2, wherein the host system is further configured to determine a route for maintaining or restocking the plurality of cabinets.

4. The system of claim 2, wherein the distribution system comprises a plurality of hand-held computing devices.

5. The system of claim 2, wherein the distribution system is configured to communicate wirelessly with the host system.

6. The system of claim 1, wherein the host system is in communication with the computer device of at least one cabinet via telephone lines.

7. A cabinet monitoring apparatus, comprising:
a cabinet configured to hold inventory;
a weight sensor for sensing a weight of the cabinet and any inventory; and
a computer device for collecting data from the weight sensor.

8. The apparatus of claim 7, further comprising an optical sensor for sensing the height of the inventory, and wherein the computer device collects data from the optical sensor.

9. The apparatus of claim 7, further comprising an entry sensor for sensing when the cabinet is accessed, and wherein the computer device collects data from the entry sensor.

10. The apparatus of claim 7, further comprising a temperature sensor for sensing the temperature inside the cabinet, and wherein the computer device collects data from the temperature sensor.

11. The apparatus of claim 7, further comprising a voltage sensor for sensing the voltage of devices powering the cabinet, and wherein the computer device collects data from the voltage sensor.

12. The apparatus of claim 7, wherein the computer device comprises a communication device for communicating the data to a remote host system.

13. The apparatus of claim 12, wherein the communication device is configured to communicate via telephone lines.

14. The apparatus of claim 7, wherein the weight sensor is a load cell.

15. The apparatus of claim 14, wherein one load cell is used to sense the weight of the cabinet and any inventory.

16. The apparatus of claim 14, wherein a plurality of load cells are used to sense the weight of the cabinet and any inventory.

17. The apparatus of claim 14, wherein the cabinet is located on a frame, and wherein at least one load cell is integrated with a support attached to the frame.

18. The apparatus of claim 17, wherein the support is a caster.

19. A cabinet monitoring apparatus, comprising:
a cabinet configured to hold inventory;
an entry sensor for sensing when the cabinet is accessed; and
a computer device for collecting data from the entry sensor and storing the number of time that the cabinet is accessed during a period of time.

20. The apparatus of claim 19, further comprising an optical sensor for sensing the height of the inventory, and wherein the computer device collects data from the optical sensor.

21. The apparatus of claim 19, further comprising a temperature sensor for sensing the temperature inside the cabinet, and wherein the computer device collects data from the temperature sensor.

22. The apparatus of claim 19, further comprising a voltage sensor for sensing the voltage of devices powering the cabinet, and wherein the computer device collects data from the voltage sensor.

23. The apparatus of claim 19, wherein the computer device comprises a communication device for communicating the data to a remote host system.

24. The apparatus of claim 23, wherein the communication device is configured to communicate via telephone lines.

25. The apparatus of claim 19, further comprising a weight sensor for sensing the weight of the cabinet and the cabinet's contents.

26. A method of monitoring a vending cabinet, comprising:
providing a plurality of cabinets at a plurality of locations, each cabinet configured to hold inventory and comprising a computer device;
sensing data about a first cabinet, the data comprising at least one of an operation of the first cabinet and an amount of inventory within the first cabinet;
collecting the data using the respective computer device;
transmitting the data and first cabinet identification information to a remote host system; and
processing the data to determine whether the first cabinet needs to be restocked or maintained.

27. The method of claim 26, further comprising sensing a number of times the cabinet is accessed within a period of time.

28. The method of claim 26, further comprising sensing a weight of the cabinet and the inventory within the cabinet.

29. The method of claim 26, further comprising communicating to a distribution system the determination of whether the cabinet needs to be restocked or maintained.

30. The method of claim 26, further comprising sensing at least one of a temperature within the first cabinet, a height of the inventory and a voltage of a power source.

31. The method of claim 26, further comprising:
sensing second data about at least one of an operation of the second cabinet and an amount of inventory within the second cabinet;
collecting the second data using the respective computer device;
transmitting the second data to the remote host system; and
processing the second data to determine whether the second cabinet needs to be restocked or maintained.

32. The method of claim 31, further comprising determining a route for restocking or maintaining the first and second cabinets based on the determination of whether the first and second cabinets need to be restocked or maintained.
